(19) United States
(12) Patent Application Publication
(10) Pub. No.: US 2026/0253392 A1
(43) Pub. Date: Aug. 27, 2026

(54) TRAINING DATASET GENERATING METHOD FOR MITIGATING OBJECT HALLUCINATION IN VISION-LANGUAGE MODEL AND HARDWARE APPARATUS

(71) Applicant: ELECTRONICS AND TELECOMMUNICATIONS RESEARCH INSTITUTE, Daejeon (KR)

(72) Inventors: Yoonhyung KIM, Daejeon (KR); Byung Ok KANG, Daejeon (KR); Hwa Jeon SONG, Daejeon (KR); In Kyu AN, Daejeon (KR)

(21) Appl. No.: 19/386,980

(22) Filed: Nov. 12, 2025

(30) Foreign Application Priority Data
Feb. 25, 2025 (KR) 10-2025-0024082

(51) Int. Cl. G06V 10/774

(52) U.S. Cl. CPC G06V 10/774

(57) ABSTRACT

A method constructing a dataset for mitigating object hallucination phenomena in a Vision-Language Model. The method may include: receiving, by a data processing apparatus, a source image dataset and a target image dataset; generating, by the data processing apparatus, association rules based on frequently occurring objects among images belonging to the source image dataset; extracting, by the data processing apparatus, a plurality of negative objects from objects of images belonging to the target image dataset using the association rules; and generating, by the data processing apparatus, a negative instruction tuning dataset for the plurality of negative objects.

### CROSS REFERENCE TO RELATED APPLICATION

The present application claims the benefit of and priority to Korean Patent Application No. 10-2025-0024082, filed Feb. 25, 2025, the entire contents of all of which are incorporated herein by reference for all purposes.

### BACKGROUND

### 1. Technical Field

The present disclosure relates to a technique for constructing training data for a Vision-Language Model. Further, the present disclosure relates to a technique for constructing a Vision-Language Model. In particular, the present disclosure relates to a technique for constructing a Vision-Language Model that is robust against Object Hallucination phenomena.

### 2. Description of Related Art

Recently, Large Language Models (LLMs) have shown high performance in various application fields such as text-based conversation, summarization, translation, and reasoning. Furthermore, LLM research is expanding to multimodal models that can process modalities other than text (video, image, audio, etc.) together. A vision-language model (VLM) is a representative type of multimodal model.

The description of the related art should not be assumed to be prior art merely because it is mentioned in or associated with this section. The description of the related art includes information that describes one or more aspects of the subject technology, and the description in this section does not limit the invention.

### SUMMARY

In one or more aspects of the present disclosure, a method for constructing a dataset for mitigating object hallucination phenomena in a Vision-Language Model includes: receiving, by a data processing apparatus, a source image dataset and a target image dataset; generating, by the data processing apparatus, association rules based on frequently occurring objects among images belonging to the source image dataset; extracting, by the data processing apparatus, a plurality of negative objects from objects of images belonging to the target image dataset using the association rules; and generating, by the data processing apparatus, a negative instruction tuning dataset for the plurality of negative objects.

In one or more aspects of the present disclosure, a hardware apparatus for constructing a training dataset for a Vision-Language Model includes: a storage device storing a source image dataset and a target image dataset; and a computing device that generates association rules based on frequently occurring objects among images belonging to the source image dataset, extracts a plurality of negative objects from objects of images belonging to the target image dataset using the association rules, and generates a negative instruction tuning dataset for the plurality of negative objects.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of an LLM-based Vision-Language Model.

FIG. 2 illustrates an example of a process for constructing a negative instruction tuning dataset.

FIG. 3 illustrates an example of a process for generating association rules used in negative object extraction.

FIG. 4 illustrates an example of a process for extracting negative objects based on association rules.

FIG. 5 illustrates an example of a hardware apparatus for generating a negative instruction tuning dataset.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION OF THE INVENTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) is described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the other element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the other element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The description below is a technique for constructing a Vision-Language Model.

The description below includes a technique for constructing a training dataset for Vision-Language Model training.

The description below includes a technique for constructing a training dataset for mitigating object hallucination phenomena.

The description below includes a technique for constructing a negative instruction tuning dataset for mitigating object hallucination phenomena.

Various models of Vision-Language Models have been researched and developed. The technology described below can be applied to any one of various types of Vision-Language Models.

An LLM-based Vision-Language Model will be briefly described. LLaVA is one of the LLM-based Vision-Language Models (see Liu et al., LLaVA: Large Language and Vision Assistant Visual Instruction Tuning, arXiv: 2304.08485v2).

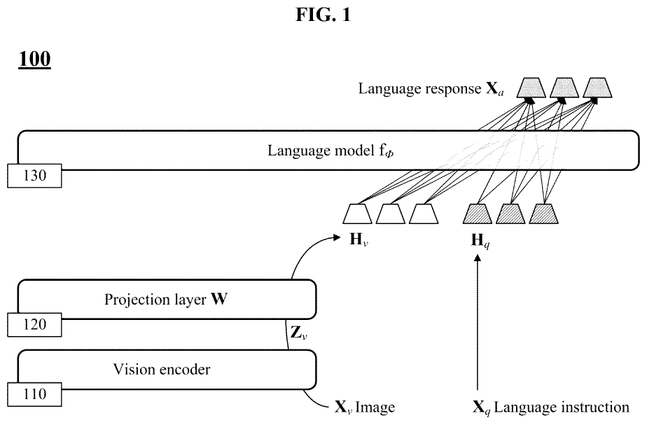

FIG. 1 illustrates an example of an LLM-based Vision-Language Model 100. The Vision-Language Model 100 is composed of a Vision Encoder 110, a Projection Layer 120, and an LLM 130. The LLM 130 and the Vision Encoder 110 are initialized with parameters of models pre-trained with respective single-modality data.

The Vision Encoder 110 receives an input image Xv and outputs visual features Zy. The Projection Layer 120 converts the visual features Zy, which are the output of the Vision Encoder 110, into linguistic features Hv and outputs them.

The LLM 130 receives a language instruction Xq and embeds certain linguistic features Hq. The LLM 130 inputs the linguistic features Hv and Hq into a decoder to output a certain language answer Xa.

The Vision-Language Model 100 can perform various vision-language modality-based tasks by applying Instruction Tuning training to perform various types of vision-language modality-based instructions such as image description, image-based conversation, and reasoning.

In the following description, it is explained that a data processing apparatus performs training dataset construction for a Vision-Language Model. The data processing apparatus may also perform training of the Vision-Language Model using a negative instruction tuning dataset. The data processing apparatus means a computer device capable of image and text processing, training data construction, controlling the training process of a Vision-Language Model, controlling Vision-Language Model operations, etc. For example, the data processing apparatus may be implemented as a PC, a server on a network, a smart device, a chipset with an embedded dedicated program, etc.

Object hallucination refers to a phenomenon of describing objects that do not exist in an input image. Objects that induce object hallucination can be broadly two types. The first is ‘Frequently Occurring Objects’ with high frequency in the dataset. The second is ‘Frequently Co-Occurring Objects’ that are frequently mentioned together with specific objects. Frequently co-occurring objects refer to pairs of objects with high probability of appearing simultaneously in the training dataset.

The data processing apparatus can mine Association Rules regarding frequently occurring objects and frequently co-occurring objects in the training dataset. The data processing apparatus can extract objects with high possibility of inducing hallucination for each image based on the association rules. Objects with high possibility of inducing object hallucination are named negative objects. The data processing apparatus can generate a negative instruction tuning dataset for negative objects. A negative instruction tuning dataset refers to a dataset composed of instructions containing invalid instructions (instructions inconsistent with the input image) and correct answers to those instructions (that the instruction is invalid or an explanation of why the instruction is invalid). The data processing apparatus can construct a Vision-Language Model robust to object hallucination phenomena by using the negative instruction tuning dataset in the training process.

The process of constructing a negative instruction tuning dataset will be described in detail below.

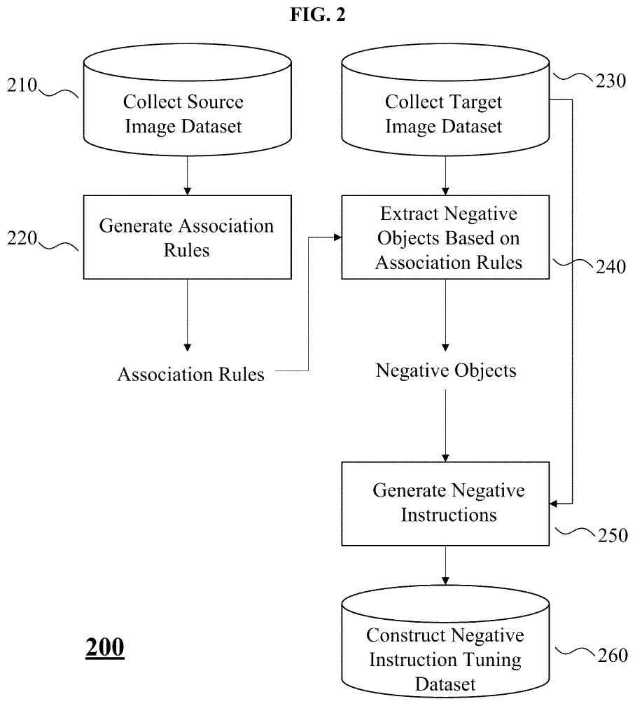

FIG. 2 illustrates an example of a process 200 for constructing a negative instruction tuning dataset.

The data processing apparatus may collect a source image dataset (210).

The data processing apparatus may receive a source image dataset.

The source image dataset is a dataset for generating association rules. The source image dataset may be composed of various types of images. The source image dataset may be a publicly available image set. It is assumed that the source image dataset includes a total of NS images.

The data processing apparatus may mine association rules between objects appearing in each image of the source image dataset (220).

Association rule mining is one of unsupervised learning techniques. Association rule mining is a technique for finding patterns in data, and can extract rules for object appearance patterns or co-occurrence within images.

The data processing apparatus can calculate association rules between objects appearing in each image through association rule mining on the source image dataset. The detailed association rule calculation process will be described later.

The data processing apparatus may collect a target image dataset (230). The target image dataset is an image dataset used for generating an instruction tuning training dataset. The target image dataset may be a different dataset from the source image dataset. Alternatively, the target image dataset may partially or entirely overlap with items of the source image dataset. It is assumed that the target image dataset includes a total of NT images.

The data processing apparatus may extract negative object(s) from each image of the target image dataset based on the association rules (240). Negative objects are objects with high possibility of inducing object hallucination phenomena among objects existing in the image, as described above. For example, negative objects may be objects that exist in the current image but have high possibility of co-occurrence based on the association rules.

The data processing apparatus may generate negative instructions for the extracted negative object(s) (250). The data processing apparatus may generate negative instructions based on the given negative object(s) for each target image unit.

For example, negative instructions may include ‘instructions to describe the number, location, etc. of objects that do not exist in the input image’, ‘conversations containing content inconsistent with the state of objects existing in the input image’, ‘conversations containing content inconsistent with relationships between objects existing in the input image’, etc. That is, negative instructions correspond to instructions or sentences that induce object hallucination phenomena.

The data processing apparatus can generate negative instructions for input images using pre-trained generative language models or Vision-Language Models such as GPT-4, Gemini, etc. For example, the data processing apparatus may request generation of instructions that do not match the image along with the input image to the generative language model.

The data processing apparatus may construct a negative instruction tuning dataset for negative objects extracted from the target image dataset (260). The negative instruction tuning dataset may be composed of negative instructions for each of the negative objects and correct answer pairs for the instructions. At this time, the correct answer may include label information indicating that the negative instruction is invalid or an explanation of why the negative instruction is invalid.

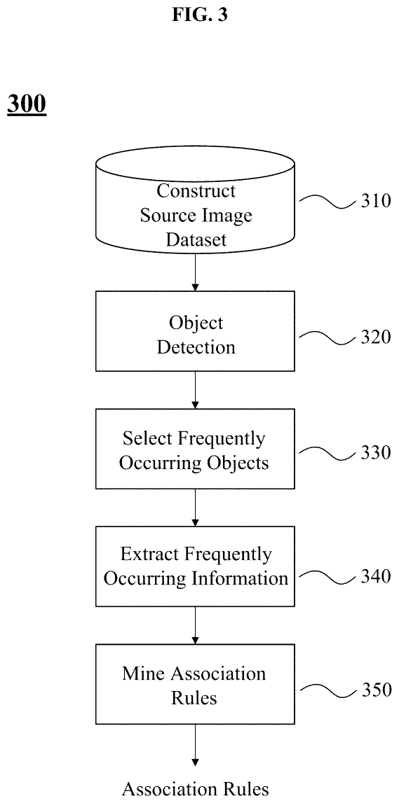

FIG. 3 illustrates an example of an association rule generation process 300 used in negative object extraction.

The data processing apparatus may construct a source image dataset (310).

The data processing apparatus may receive a source image dataset.

The data processing apparatus may perform object detection for each image belonging to the source image dataset (320). Any one of various algorithms or learning models may be used for object detection. For example, the data processing apparatus may detect objects in each image using a trained object recognition model or semantic segmentation model. At this time, object detection may include object type information.

In some cases, the source image dataset may include information about each object. In this case, the data processing apparatus may not perform the object detection process.

The data processing apparatus can calculate the types of objects and the number of occurrences of each type of object through object detection for images.

The data processing apparatus may select frequently occurring objects based on the detected object types and the number of occurrences of each type of object (330).

For example, the data processing apparatus may determine the number K of frequently occurring objects according to a threshold obtained by applying Otsu Thresholding to a histogram sorted according to the size of the number of object occurrences. Meanwhile, K may also be set to an arbitrary value.

The data processing apparatus may extract information about frequently occurring objects (340). Frequently occurring information may include support and confidence for frequently occurring objects. Support and confidence can be used for association rule extraction.

The data processing apparatus can calculate support values for K frequently occurring objects as shown in Equation 1 below.

$$Support ( A ) = \frac{Number of images containing A}{{N}_{S}} \qquad [ Equation 1 ]$$

In Equation 1, A is a set of objects, and Support(⋅) is a support function that calculates the ratio of A occurring among all images. At this time, A may be the set of K frequently occurring objects described above.

The data processing apparatus can calculate support for combinations of object(s) existing in the source image dataset. At this time, the combination includes all possible sets composed of one or more objects. The data processing apparatus can calculate support for each item (composed of one or more objects) included in the combination. The data processing apparatus can select items among items included in the combination that are above the minimum support. The minimum support can be set to a value between (0.0, 1.0).

The data processing apparatus can extract an object set S having support equal to or greater than the minimum support. S can be composed of a frequent set Ai having support equal to or greater than the minimum support and the support ai of the set, as shown in Equation 2 below.

$$S = \{ ( {A}_{i} , {a}_{i} ) \vert i = 1 , 2 , … , {N}_{Freq} \} \qquad [ Equation 2 ]$$

In Equation 2, N_{Freq} is the number of sets whose support is equal to or greater than the minimum support among all object combinations.

The data processing apparatus can calculate confidence between frequent sets based on the set S as shown in Equation 3 below.

$$Confidence ( {A}_{i} \to {A}_{j} ) = \frac{Support ( {A}_{i} ⋃ {A}_{j} )}{Support ( {A}_{i} )} , where i \neq j \qquad [ Equation 3 ]$$

Equation 3 is a confidence function that calculates the probability that a Consequent set Aⱼ occurs when an Antecedent set Aᵢ is given. The antecedent set is a set of objects that become preceding occurrence conditions, and the consequent set refers to a set of subsequent objects that appear simultaneously with the preceding objects.

That is, confidence indicates the possibility that objects of object set Aⱼ appear simultaneously under the premise that object set Aᵢ appears in a specific image. Therefore, the value of Confidence (Aᵢ→Aⱼ) can be seen as an indicator of the possibility that elements of Aⱼ set will induce object hallucination in images where all elements (objects) of Aᵢ set appear.

The data processing apparatus may mine association rules based on the set S and confidence information (350). The data processing apparatus can obtain confidence of all possible combinations for components of S composed of N_{Freq} elements, and then select only those whose confidence is equal to or greater than the minimum confidence. The minimum confidence can be arbitrarily set in the range (0.0, 0.1). This selected confidence set is the association rule. Association rules can be defined as shown in Equation 4 below. The association rules below indicate the possibility of co-occurrence of any possible pair combination (antecedent object and consequent object) among frequently occurring objects.

$$Z = \{ ( {A}_{i} , {A}_{j} , {c}_{l} ) \vert i ∈ \{ 1 , 2 , … , {N}_{Freq} \} , j ∈ \{ 1 , 2 , … , {N}_{Freq} \} , i \neq j , l = 1 , 2 , … , {N}_{Rule} \} \qquad [ Equation 4 ]$$

Equation 4, ci is the value of Confidence (Aᵢ→Aⱼ). The association rule indicates the possibility that when antecedent object Aᵢ appears, consequent object Aⱼ appears concurrently.

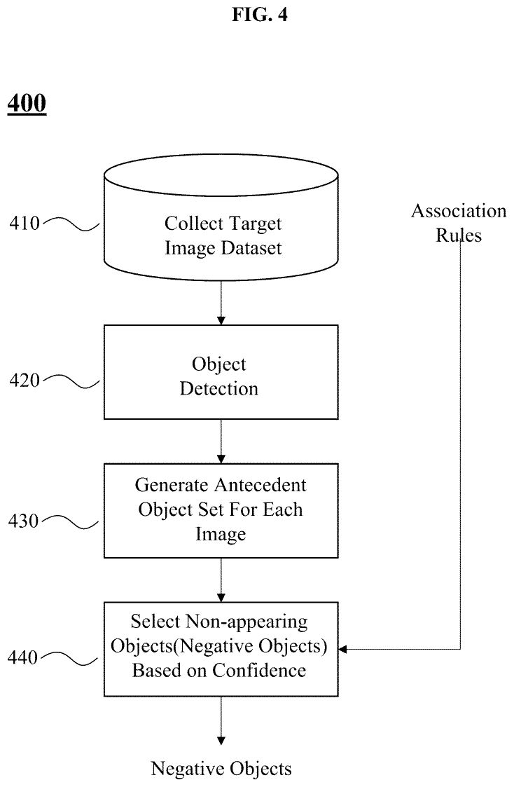

FIG. 4 illustrates an example of a process 400 for extracting negative objects based on association rules.

The data processing apparatus may collect a target image dataset (410). The target image dataset is an image dataset used for generating an instruction tuning training dataset.

The data processing apparatus may receive a target image dataset.

The data processing apparatus may perform object detection for each image belonging to the target image dataset (420). Any one of various algorithms or learning models may be used for object detection. For example, the data processing apparatus may detect objects in each image using a trained object recognition model or semantic segmentation model. At this time, object detection may include object type information.

In some cases, the target image dataset may include information about each object. In this case, the data processing apparatus may not perform the object detection process.

The data processing apparatus may generate an antecedent object set appearing in the target image (430). The data processing apparatus can obtain an antecedent object set appearing in the target image by performing object detection for each image belonging to the target image dataset. The antecedent object set may consist only of frequently occurring objects.

The data processing apparatus may select confidence-based non-appearing objects (negative objects) using the antecedent object set for the target image and the consequent object set (440).

Various types of objects may exist in the input image. Therefore, if the components of the antecedent object set increase, the consequent object set for the given antecedent object set may not be included in the association rules. To supplement this problem, the data processing apparatus can extract consequent object sets for all subsets of the antecedent object set. The data processing apparatus can select only those whose confidence is equal to or greater than the minimum confidence among the extracted consequent object sets. At this time, the data processing apparatus can use association rules to select those whose confidence is equal to or greater than the minimum confidence for consequent objects. The data processing apparatus can determine objects that do not belong to the antecedent object set of the target image dataset among elements of the selected consequent object set as negative objects. At this time, negative objects are objects that did not appear in the target image but have high possibility of co-occurrence based on the information of appeared objects. That is, this process is for the data processing apparatus to select consequent objects with high confidence from the target image dataset using association rules generated based on the source dataset, and to select the objects as negative objects when the selected consequent objects do not belong to the antecedent object set of the target image dataset.

The data processing apparatus may extract frequently occurring objects among objects detected from the target image dataset. At this time, frequently occurring objects may be objects whose number of occurrences is equal to or greater than a certain threshold. The data processing apparatus can select antecedent object and consequent object pairs from frequently occurring objects extracted from the target image dataset. The data processing apparatus can select only consequent objects whose confidence is equal to or greater than the minimum confidence as described above. At this time, the data processing apparatus can use association rules to select those whose confidence is equal to or greater than the minimum confidence for consequent objects. The data processing apparatus can select the consequent object as a negative object when the selected consequent object does not belong to the antecedent object set.

The performance of a Vision-Language Model adjusted with a negative instruction tuning dataset was verified. LLaVA 1.5 was used as the baseline model, and the proposed model is a model trained with a negative instruction tuning dataset for LLaVA 1.5. Performance was verified with questions about object existence using the POPE dataset. Table 1 below shows the verification results.

TABLE 1

| | POPE metric | | | | | | | | |
|---|---|---|---|---|---|---|---|---|---|
| | Adversarial | | | Popular | | | Random | | |
| | Accuracy | Precision | F1 | Accuracy | Precision | F1 | Accuracy | Precision | F1 |
| LLaVA 1.5 | 85.3 | 90.4 | 84.3 | 87.2 | 94.4 | 86.0 | 88.4 | 97.4 | 87.2 |
| Proposed | 86.5 | 93.3 | 85.3 | 87.7 | 96.0 | 86.5 | 88.7 | 98.4 | 87.4 |

In Table 1, the POPE metric consists of Yes/No questions about object existence. Verification was performed for three types. Adversarial is an object that induces object hallucination. Popular is a frequently occurring object. Random is a randomly selected object. In Table 1, Proposed (proposed model) is an LLM-based Vision-Language Model trained with a negative instruction tuning dataset. The proposed model showed higher performance overall than the baseline model. In particular, the proposed model showed high performance even for objects inducing object hallucination.

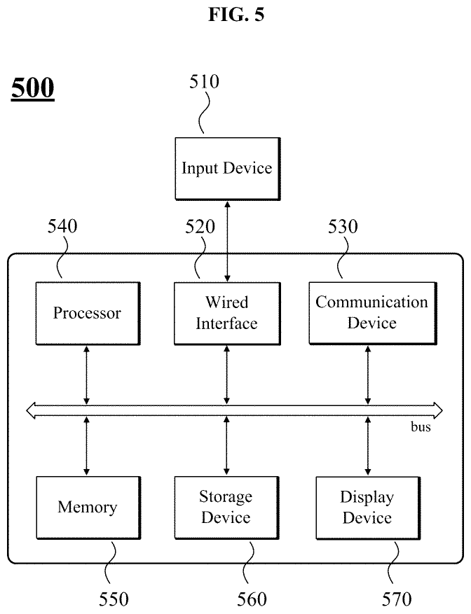

FIG. 5 illustrates an example of a hardware apparatus 500. The hardware apparatus 500 corresponds to the data processing apparatus described above. The hardware apparatus 500 may take the form of a computer device, smart device, network server, data processing dedicated chipset, etc.

The hardware apparatus 500 may include an input device 510, a wired interface 520, a communication device 530, a processor 540, a memory 550, and a storage device 560.

Additionally, the hardware apparatus 500 may include an input device 510, a wired interface 520, a communication device 530, a processor 540, a memory 550, a storage device 560, and a display device 570.

Each internal component of the hardware apparatus 500 may be connected by a bus. The bus may use a specific bus depending on the type of entity being connected. For example, the bus may be any one of AMBA (AHB/AXI/APB), PCIe, SPI (Serial Peripheral Interface), or MIPI (Mobile Industry Processor Interface).

The input device 510 is a device that receives user commands or information.

Additionally, the input device 510 may be a device that receives necessary data from an external device or storage device physically connected.

The input device 510 may receive a source image dataset and a target image dataset from a user.

The input device 510 may receive a source image dataset and a target image dataset from an external object or storage device.

The input device 510 may be any one of various types of devices. For example, the input device 510 may be at least one of a mouse, keyboard, touch input device, camera, Small Computer System Interface (SCSI) device, Peripheral Component Interconnect (PCI) bus-based device, or ATA Packet Interface (ATAPI) device.

The wired interface 520 is a device component that transmits data delivered by the input device 510 inside the device. The wired interface 520 may consist of software drivers and hardware.

The wired interface 520 may include a controller corresponding to each input device, a device driver that controls the operation of the controller, and a kernel I/O subsystem that integrally manages input/output control requests of the device driver. The kernel I/O subsystem stores input/output requests from device drivers in a queue and schedules the requests based on request priority or device status.

The wired interface 520 may include interfaces such as PS/2, Universal Serial Bus (USB), Ethernet port, HDMI, MIPI CSI, DisplayPort, Thunderbolt, etc.

The wired interface 520 may transmit the calculated negative instruction tuning dataset to other components within the device or external objects.

The wired interface 520 may transmit the trained vision-language model to other components within the device or external objects.

The communication device 530 refers to a component that receives and transmits certain information through an external wired or wireless network. The communication device 530 may consist of circuits including an antenna and a communication module (S/W module, chip, etc.) corresponding to the communication protocol. The communication protocol may be at least one of wired LAN (Ethernet), wireless LAN (IEEE 802.11), mobile communication (LTE, 5G NR, etc.), Bluetooth, NFC, etc.

The communication device 530 may receive a source image dataset and a target image dataset.

The communication device 530 may transmit the calculated negative instruction tuning dataset to an external object.

The communication device 530 may transmit the trained Vision-Language Model to an external object.

The processor 540 controls the operation of all components of the hardware apparatus 500. Additionally, the processor 540 controls the process of visualizing simulation data.

The processor 540 may perform operations on at least one application or computer program for executing methods/operations according to various embodiments of the present disclosure.

The processor 540 is a general-purpose processor that executes at least part of a control program installed in the storage device 560 or at least part of a program loaded in the memory 550.

The processor 540 may be implemented as circuitry (e.g., processing circuitry) such as a system on chip (SoC) or integrated circuit (IC).

The processor 540 may include one or more processors. For example, the processor 540 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any type of processor well known in the technical field of the present disclosure.

The memory 550 may store data and information generated in the process of generating a negative instruction tuning dataset. The memory 550 may also store data and information generated in the process of training a Vision-Language Model using a negative instruction tuning dataset. The memory 550 is volatile memory such as DRAM or SRAM.

The storage device 560 may store a source image dataset. The source image dataset is a dataset for calculating association rules.

The storage device 560 may store a target image dataset. The target image dataset is a dataset for calculating a negative instruction tuning dataset. The target image dataset may be a different dataset from the source image dataset. Alternatively, the target image dataset may be the same dataset as the source image dataset. Alternatively, the target image dataset may include images identical to some images in the source image dataset.

The storage device 560 may store a negative instruction tuning dataset.

The storage device 560 may also store a trained Vision-Language Model.

The storage device 560 may be implemented as a device such as a hard disk drive, Solid State Drive, USB flash drive, memory card, optical disk, or network-based storage device (Network Attached Storage, cloud storage, etc.).

The display device 570 may output interfaces, negative instruction tuning datasets, images, negative objects, etc. necessary for the process of constructing a negative instruction tuning dataset.

The display device 570 may be implemented as various types of devices.

The display device 570 may be implemented with various display methods such as liquid crystal, plasma, light-emitting diode, organic light-emitting diode, surface-conduction electron-emitter, carbon nano-tube, nano-crystal, etc.

The processor 540 may mine association rules from the source image dataset. The processor 540 may calculate association rules as shown in Equation 4 through the process described in FIG. 3.

The processor 540 may calculate negative objects by applying association rules to the target image dataset. The processor 540 may calculate a plurality of negative objects through the process described in FIG. 4.

The processor 540 may generate negative instructions for negative objects. The processor 540 may generate negative instructions using a generative model.

The processor 540 may request generation of negative instructions by transmitting information of target images and negative objects to an LLM. At this time, the communication device 530 may transmit information of target images and negative objects to an external LLM server and receive generated negative instructions from the server.

The processor 540 may generate correct answers for negative instructions for negative objects. For example, the processor 540 may generate correct answers for negative instructions using a generative model. At this time, the correct answer may include label information indicating that the negative instruction is invalid or an explanation of why the negative instruction is invalid.

Alternatively, the input device 510 or communication device 530 may receive or receive correct answers for negative instructions from a user.

The processor 540 may construct a negative instruction tuning dataset by matching negative instructions for negative objects with correct answer pairs. The processor 540 may construct a negative instruction tuning dataset with a plurality of negative instructions and correct answer pairs.

Furthermore, the processor 540 may perform adjustment or training of the Vision-Language Model using the negative instruction tuning dataset.

Methods according to embodiments described in the specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the specification of the present disclosure.

In addition, the negative instruction tuning dataset construction method and/or Vision-Language Model construction method using a negative instruction tuning dataset as described above may be implemented as a program (or application) including executable algorithms that can be executed on a computer. The program may be provided stored on a transitory or non-transitory computer readable medium.

The non-transitory computer readable medium refers to a medium that stores data semi-permanently (e.g., the storage device) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method for constructing a training dataset for mitigating object hallucination phenomena in a Vision-Language Model, comprising:
receiving, by a data processing apparatus, a source image dataset and a target image dataset;
generating, by the data processing apparatus, association rules based on frequently occurring objects among images belonging to the source image dataset;
extracting, by the data processing apparatus, a plurality of negative objects from objects detected in images of the target image dataset using the association rules; and
generating, by the data processing apparatus, a negative instruction tuning dataset for the plurality of negative objects,
wherein the negative instruction tuning dataset includes a negative instruction for each of the plurality of negative objects and a correct answer pair for the negative instruction, and the negative instruction is an instruction or sentence that induce object hallucination.

2. The method of claim 1, wherein generating the association rules comprises:
detecting, by the data processing apparatus, objects in each of the images belonging to the source image dataset;
extracting, by the data processing apparatus, frequently occurring objects based on the number of occurrences among a plurality of objects detected in the images; and
generating, by the data processing apparatus, the association rules indicating co-occurrence possibility of the two objects for each pair of frequently occurring objects.

3. The method of claim 1, wherein the data processing apparatus:
extracts frequently occurring objects having support equal to or greater than minimum support from all frequently occurring objects belonging to all images, based on support which is a ratio of the number of images including frequently occurring objects to the number of all images belonging to the source image dataset, and
generates the association rules indicating possibility that the antecedent object and the consequent object appear simultaneously for one antecedent object and one consequent object pair among frequently occurring objects having support equal to or greater than the minimum support.

4. The method of claim 1, wherein extracting the negative objects comprises:
detecting, by the data processing apparatus, objects in each of images belonging to the target image dataset;
selecting, by the data processing apparatus, consequent objects having confidence equal to or greater than a threshold among a plurality of objects detected in the target image dataset based on the association rules; and
determining, by the data processing apparatus, the consequent object as the negative object when the consequent object does not belong to a set of antecedent objects detected in the target image.

5. The method of claim 1, wherein the data processing apparatus generates the negative instruction for the negative object using a trained generative language model.

6. The method of claim 1, further comprising performing, by the data processing apparatus, instruction tuning training for a Vision-Language Model using the negative instruction tuning dataset.

7. A hardware apparatus for constructing a training dataset for a Vision-Language Model, comprising:
a storage device configured to store a source image dataset and a target image dataset; and
a computing device configured to generate association rules based on frequently occurring objects among images belonging to the source image dataset, extract a plurality of negative objects from objects detected in images of the target image dataset using the association rules, and generate a negative instruction tuning dataset for the plurality of negative objects,
wherein the negative instruction tuning dataset includes a negative instruction for each of the plurality of negative objects and a correct answer pair for the negative instruction, and the negative instruction is an instruction or sentence that induce object hallucination.

8. The hardware apparatus of claim 7, wherein the computing device:
extracts frequently occurring objects having support equal to or greater than minimum support from all frequently occurring objects belonging to all images, based on support which is a ratio of the number of images including frequently occurring objects to the number of all images belonging to the source image dataset, and
generates the association rules indicating possibility that the antecedent object and the consequent object appear simultaneously for one antecedent object and one consequent object pair among frequently occurring objects having support equal to or greater than the minimum support.

9. The hardware apparatus of claim 7, wherein the computing device:
selects consequent objects having confidence equal to or greater than a threshold from objects detected in each of images belonging to the target image dataset based on the association rules, and determines the consequent object as the negative object when the consequent object does not belong to a set of antecedent objects according to the association rules among the detected objects.

10. The hardware apparatus of claim 7, wherein the computing device generates the negative instruction for the negative object using a trained generative language model.

11. The hardware apparatus of claim 7, wherein the computing device performs instruction tuning training for a Vision-Language Model using the negative instruction tuning dataset.
